(19) United States
(12) Patent Application Publication
(10) Pub. No.: US 2009/0055492 A1
(43) Pub. Date: Feb. 26, 2009

(54) Consolidating messages

(76) Inventors: Robert A. Hubbs, Kelowna (CA); Sean C. Carroll, Kelowna (CA)

Correspondence Address: Antony C. Edwards, P.O. Box 26020, Westbank, BC, V4T 2G3, CA

(21) Appl. No.: 12/073,222

(22) Filed: Mar. 3, 2008

Related U.S. Application Data
(60) Provisional application No. 60/904,388, filed on Mar. 2, 2007.

(51) Int. Cl. G06F 15/16

(52) U.S. Cl. 709/206

(57) ABSTRACT

Disclosed is an apparatus and method for consolidating received messages from a plurality of devices. Each of the received messages has a condition portion representing at least one condition being reported by at least one of said plurality of devices. The apparatus comprises a receiver, a processor, and a transmitter. The method comprises receiving at least one received message from the plurality of devices, selecting at least one transmit condition from the at least one conditions being reported by the plurality of devices, and transmitting a transmit message having a transmit condition portion and a transmit identifier portion. The transmit condition portion is selected so as to optimize the length of the transmit identifier portion.

### CROSS REFERENCE TO RELATED APPLICATION

This application claims priority from United States Provisional Patent Application No. 60/904,388 filed Mar. 2, 2007 entitled Quorum Based Intelligent Message Consolidation.

### BACKGROUND OF THE INVENTION

1. Field of Invention

The present invention relates to message consolidation, particularly in a network. More particularly, the invention relates to a method and apparatus for consolidating messages received at a node of the network to optimize the size of an outputted message representing the status of a portion of the network.

2. Description of Related Art

Networks incorporating distributed or remote nodes, components or devices have traditionally posed several problems of reliability. Due to the remote location or distributed nature of these types of networks, they have been prone to interrupted or sporadic communication and a greater likelihood of missed messages or data. Larger networks further exacerbate these problems by increasing the number of devices that all add to the communal network traffic.

Power line and radio frequency communication, in particular have been found to be prone to limitations affecting previous strategies for monitoring and controlling remote devices. Both are known to have significant problems with higher bandwidth due to the interference of noise and loss of signal.

Additionally, the need for the remote or distributed devices to be in continuous or intermittent communication with a central or master unit as well as with each other may create a large amount of network traffic that may further obscure critical communication between two specific devices.

Previous attempts to ensure that these devices remain in communication with each other has not significantly helped in cases where there are low bandwidth restrictions. In particular, efforts to combine messages only creates larger messages by stringing together the combined messages one after the other. These combined messages do not therefore reduce network traffic and may serve to reduce the reliability of the network due to the greater risk of error being introduced into the larger messages. In low bandwidth environments, these solutions may also limit the speed at which devices may communicate due to the large messages requiring longer transmission and verification times.

### SUMMARY OF THE INVENTION

According to a first embodiment of the present invention there is disclosed a method of consolidating received messages from a plurality of devices. Each of the received messages has a condition portion representing at least one condition being reported by at least one of said plurality of devices. The method comprises receiving at least one received message from the plurality of devices, selecting at least one transmit condition from the at least one conditions being reported by the plurality of devices, and transmitting a transmit message having a transmit condition portion and a transmit identifier portion. The transmit condition portion comprises the at least one transmit condition and wherein the transmit identifier portion represents the plurality of devices reporting the at least one transmit condition.

Each of the at least one conditions of the received messages may be one of a set of mutually exclusive conditions. The set of mutually exclusive conditions may comprise first and second conditions.

Each of the received messages may further include a received identifier portion representing a reporting group of the plurality of devices reporting each of the at least one condition. The received identifier portion may comprise a list of the plurality of devices reporting each of the at least one conditions. The received identifier portion may comprise a quantity of the plurality of devices reporting each of the at least one conditions. The plurality of devices may report corresponding reported messages in an ordered sequence, wherein a unique identity of each of the plurality of devices is determined by a position of the device in the ordered sequence.

The method may further comprise recording the at least one received messages, compiling a condition count corresponding to each of the at least one condition being reported by the plurality of devices, and comparing said condition counts. The selecting comprises selecting one of the condition counts so as to optimize the length of the transmit message.

Each of the condition counts may correspond to a quantity of the plurality of devices reporting the corresponding at least one condition. Each of the condition counts may include a list of the plurality of devices reporting the corresponding at least one condition. The transmit condition may be selected such that the transmit identifier portion is an optimized list selected from the group consisting of all of the plurality of devices, none of the plurality of devices and at least one of the condition counts. The at least one of the condition counts may comprise half of all of the plurality of devices. The at least one of the condition counts may comprise less than half of all of the plurality of devices.

Selecting may comprise selecting one of the condition counts so as to optimize the length of the transmit message. Selecting may comprise selecting one of the condition counts so as to optimize the length of the transmit identifier portion of the transmit message. Each of the received messages include a plurality of condition portions each represent a condition being reported by at least one of the plurality of devices.

The transmit message may comprise a plurality of the transmit conditions each having a transmit identity portion. The transmit message may include an optimized list of each transmit identifier portion for each of the transmit conditions. The plurality of devices may comprise a predefined set of devices having known identifications. Each condition portion may represent a plurality of conditions being reported by at least one of the plurality of devices.

The transmit condition may comprise at least one condition selected to optimize a length of the transmit identifier portion. The message may include a plurality of condition portions each representing at least one condition being reported by at least one of the plurality of devices. The plurality of devices may comprise a distributed network wherein the received messages are received at a first device of the distributed network.

According to a first embodiment of the present invention there is disclosed a apparatus for consolidating received messages from a plurality of devices. Each of the received messages has a condition portion representing at least one condition being reported by at least one of the plurality of devices. The apparatus comprises a receiver for receiving at least one received message from the plurality of devices, a processor for selecting at least one transmit condition from the at least one conditions being reported by the plurality of devices, and a transmitter transmitting a transmit message having a transmit condition portion and a transmit identifier portion. The transmit condition portion comprises the at least one transmit condition and wherein the transmit identifier portion represents the plurality of devices reporting the at least one transmit condition.

The apparatus may further comprise a memory for recording the at least one received messages. Each of the received messages may further include a received identifier portion representing a reporting group of the plurality of devices reporting each of the at least one condition. The processor may be adapted to compile a condition count corresponding to each of the at least one condition being reported by the plurality of devices in the memory; and compare the condition counts. Selecting may comprises selecting one of the condition counts so as to optimize the length of the transmit message.

### BRIEF DESCRIPTION OF THE DRAWINGS

In drawings which illustrate embodiments of the invention wherein similar characters of reference denote corresponding parts in each view,

FIG. 1 is a cross-sectional view of a building having a plurality of distributed devices.

FIG. 2 is a schematic view of a portion of a distributed network having message consolidation at a consolidating device.

FIG. 3 is a process flow diagram of a method for receiving messages at a device for consolidation and output to a master device.

FIG. 4 is a diagram of a method for optimizing the list of devices and their conditions to an optimized list of devices having a condition as incorporated into the process of FIG. 3.

FIG. 5 is an illustration of a list of reporting devices and their respective conditions.

FIG. 6 is an illustration of an optimized list of reporting a condition and the devices having that condition.

FIG. 7 is an illustration of an optimized two condition list first and second conditions and the devices having the first and second conditions.

FIG. 8 is a schematic illustration of a device for consolidating messages according to the process of FIG. 3.

### DETAILED DESCRIPTION

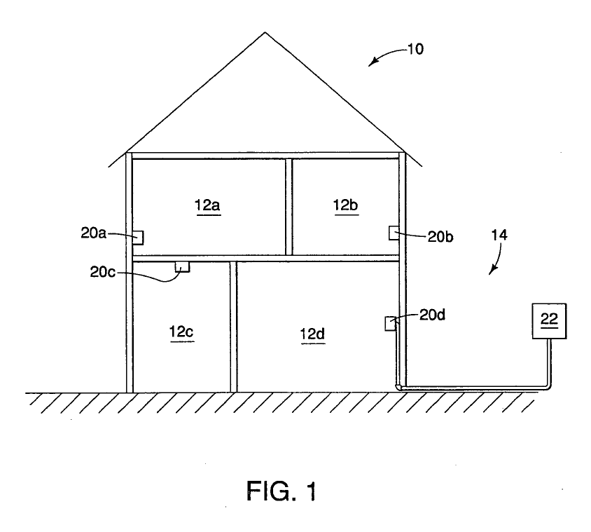

Referring to FIG. 1, an building is shown generally at 10 having a plurality of rooms or zones 12a, 12b, 12c, and 12d, respectively and a plurality of corresponding distributed devices 20a, 20b, 20c and 20d therein. It will be appreciated that the distributed devices 20a, 20b, 20c and 20d may be any number of remote devices, such as, by way of non-limiting example process control devices, sensing modules or data relays.

The messages between devices may be transmitted directly between devices such as for example, by direct communication wires, through power line wires or through a radio frequency (RF) transmission. It will be appreciated that the methods of the present application for consolidating messages will be applicable to any known method of transmitting these messages between devices of such a network.

The distributed devices 20a, 20b, 20c and 20d are in communication with a master device 22 having top level control of the distributed network. In the present embodiment, the distributed network 14 comprises all of the distributed devices 20a, 20b, 20c and 20d and the master device. It will be appreciated that in other embodiments the distributed network 14 may comprise a plurality of devices in the same or different buildings. It will also be appreciated that the master device 22 may be located in the same building as some or all of the distributed devices or in a separate building.

The method described below may be performed by any one of or all of the distributed devices 20a, 20b, 20c and 20d or within the master device 22. As discussed further below, the present invention will permit one distributed device to collect, combine and retransmit messages from a group of the network to the master device 22 or to another device so as to reduce the overall traffic on the network.

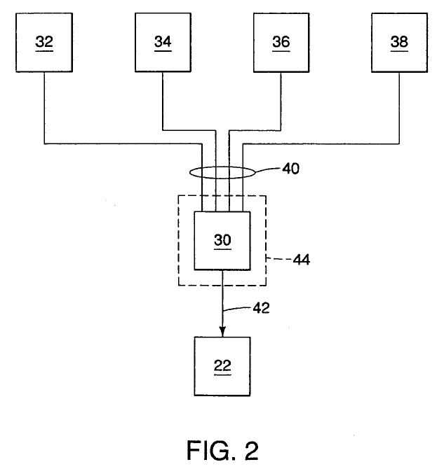

Turning now to FIG. 2, an embodiment of the present invention is illustrated having first, second, third and fourth reporting devices 32, 34, 36 and 38 reporting to a consolidating device 30. In the present embodiment, all of the first, second, third, fourth and reporting devices 32, 34,36, 38 and 30 may be similar devices such that all of the first, second, third, fourth and consolidating devices may be interchangeable with each other.

The first, second, third and fourth reporting devices 32, 34, 36 and 38 are connected to the consolidating device 30 with network input connections 40. The network connection may be power line wires in the case of a power line communicator, RF links, dedicated network connections or any other type of known connection. The consolidating device 30 includes a corresponding network output connection 42 which may also be power line wires in the case of a power line communicator, RF links, dedicated network connections or any other type of known connection. For convenience, the consolidating device 30 along with all of its associated network input connections 40 and its network output connection 42 will be identified as node 44.

It will be appreciated that each of the first, second, third and fourth reporting devices 32, 34, 36 and 38 may be single end devices or may also previously consolidated messages from a lower level group of distributed devices. In the case where one of the first, second, third and fourth reporting devices 32, 34, 36 and 38 has consolidated messages for a previous group, the message transmitted to the consolidating device 30 will be a consolidated message in accordance with the methods described below.

During operation of the network, a master device 22 transmits a question or inquiry to the entire network. The master device 22 may be located within the building 10 or at another remote location where the network may comprise a single or a plurality of buildings. The inquiry may relate to the condition of the whole or a part of the network. The inquiry may ask a question having a discrete set of possible answers or a question relating to a value or the number of devices having a particular question. For example, without limiting the generality of the forgoing, the question may be “flow sensed?” in a system having a plurality of flow sensors. It will be appreciated that for other types of networks having different devices, different questions will also be appropriate. It will be appreciated that the answer could be yes/no, binary, A/B or other small set. The answer could be reported in a message having an identity tag and the answer. The answer could also be only the answer where the devices report in sequence. In this case the identity for each answer would be inferable from the order of all of the answers.

In response to the inquiry asked by the master device 22, the devices 32, 34, 36 and 38 will transmit a reply that is received by the consolidating device 30 through network input connections 40. Although the devices 32, 34, 36 and 38 will transmit the message broadly to the network, the message may only be received and interpreted by the consolidating device 30 in some embodiments of the present invention. In other embodiments of the present invention, the devices 32, 34, 36 and 38 may transmit the message broadly, however due to interference in some areas of the network or other considerations, the message may only be unobscured at certain devices in a local area.

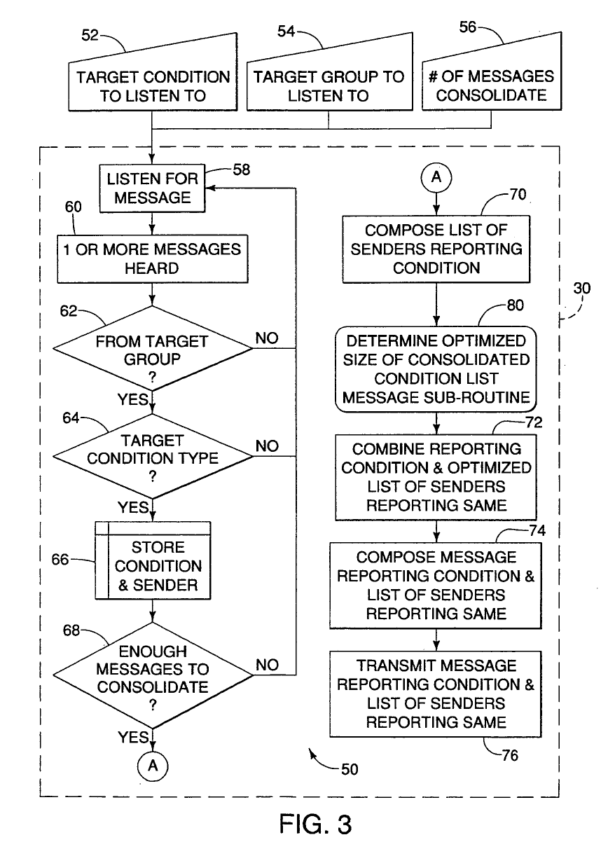

Referring to FIG. 3, a process flow diagram illustrating a process 50 for one embodiment of the present invention is illustrated. It will be appreciated that the process 50 illustrated in FIG. 3 may be performed within a single consolidating device 30 or node of a network or may optionally be performed in a group of devices. Advantageously, the process of the present application may be performed simultaneously in a plurality of devices of a network. As illustrated in FIG. 3, the process 50 is performed in a single consolidating device 30.

As illustrated, the consolidating device 30 is provided with a target condition being reported by the other devices in step 52, a target group of devices to listen for in step 54 and optionally a number of messages to be consolidated in step 56 by the consolidating device. It will be appreciated that the number of messages to consolidate 56 may be optional in embodiments where the consolidating device is to consolidate and report on a regular time sequence. In these embodiments, the number of messages to be consolidated will be determined by the number of messages received during that time period. The target group defined in 54 may be the entire network or optionally a pre-selected subset of the network as defined by a user. It will also be appreciated that the consolidating device 30 may be adapted to listen for and record information concerning any condition reported in the proper format on the network. Accordingly, the consolidating device 30 may be requested by the master device 22 or another consolidating device to report any one or multiples of such conditions as it has received as required.

The consolidating device 30 listens for a message over the network in step 58. When a message is received in step 60, the consolidating device 30 compares the message sender in step 62 to determine if it is from the target group defined in 54. If the message is not from the target group 54, the consolidating device 30 returns to listening for a message in step 60. If the message is from the target group 54, the consolidating device the compares the message content in step 64 to the target conditions to be listened for as defined in step 52. If the message is not one of the target conditions types, the consolidating device 30 returns to listening for a message in step 60. If the message content is one of the target conditions, then both the message sender and message content are stored in step 66 as further discussed below.

As illustrated in step 68, after storing each message, the consolidating device 30 compares the stored message sender and message contents from step 66 to the number of messages to consolidate defined by 56. If the number of messages to consolidate is not at the defined amount, the consolidating device 30 returns to step 58 to listen for another message. If the number of message to consolidate is at the defined amount the consolidating device 30 proceeds to step 70 where the consolidating device 30 composes a list of senders reporting the target condition. It will be appreciated that for embodiments where the number of messages to consolidate is not pre-defined, that step 68 may be omitted wherein the consolidating device 30 may proceed from step 66 to 70 on a regular time interval or as requested by a master device 22 or from another source.

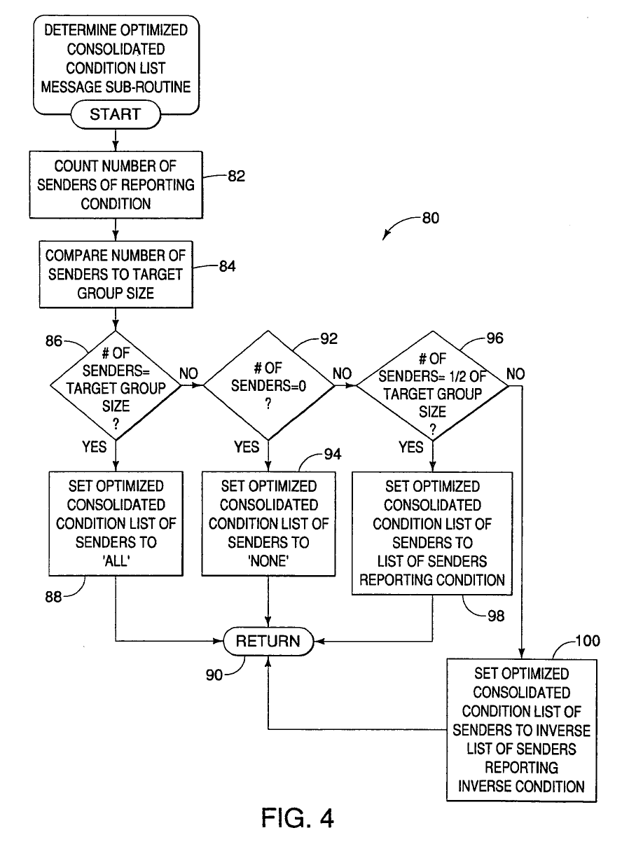

After the consolidating device 30 has composed a list of sending devices reporting a target condition, the consolidating device performs a message optimization process 80 as further described below with reference to FIG. 4 which determines an optimized size of the message required for the consolidating device 30 to report the status of the composed list of sending devices to a master device 22 or other source. The consolidating device 30 combines the transmit condition and optimized list of reporting devices as determined by the message consolidation process 80 in step 72. The transmit condition is the condition being reported by the consolidating device 30 to a master whereas the optimized list of senders is a list representing all of the devices that are reporting the transmit condition. The consolidating device then composes the reporting condition and optimized list of senders into a transmit message and transmits the transmit message in steps 74 and 76, respectively.

Turning now to FIG. 4, the message optimization process 80 is illustrated. The message optimization process 80 receives a list of all sender devices and their respective condition and outputs and a consolidated condition and an optimized list those sender devices and having the consolidated conditions. The list of sending devices reporting a target condition from step 70 is utilized to compile a number of senders of each reporting condition in step 82. It will be appreciated that for conditions which have only one of two possible reporting answers, a single count of only devices reporting the positive or negative option may be necessary. By way of non-limiting example, the inquiry asked by the master device 22 may require a positive or negative response. In these cases, where the identities of all of the sender devices is known, it will only be necessary to compile a count of the positive responses as the negative responses may be determined by the inverse of the positive responses.

At step 84 the count of senders from step 82 for the condition is compared to the target group size as provided by 56. In embodiments where the target group size 56 is not provided the target group size may be determined by the list of senders composed in step 70. In step 86, the consolidating device 30 compares the condition count to the target group size. If the condition count is equal to the target group size, the condition is set to the condition associated with the condition count and the list of senders as described more fully below is set to “ALL” in step 88. If the condition count is not equal to the target group size, the consolidating device 30 compares the condition count to zero in step 92. If the condition count is equal to zero, the condition is set to the condition associated with the condition count and the list of senders is set to “NONE” in step 94.

If the condition count is not equal to zero, the consolidating device 30 compares the condition count to one half of the target group size in step 96. If the condition count is less than half of the target group size, the condition is set to the condition associated with the condition count and the list of senders is set to a list of the devices reporting that condition in step 98. If the condition count is not less than half of the target group size, the condition is set to the condition associated with the inverse of the condition count and the list of senders is set to the inverse of the list of devices in the condition count in step 100.

More particularly, the message optimization process 80 selects a condition and compiles a list of the devices reporting that condition. The message optimization process 80 then compares that count to a list of all of the target group size and determines which of the sender lists selected from “ALL”, “NONE”, a list of devices reporting the condition and a list of devices reporting the inverse of the condition will be the shortest. After the condition count it's associated list of sender devices are set to the desired lists from above, the condition and list of sender devices are outputted from the message consolidation process 80 at step 90.

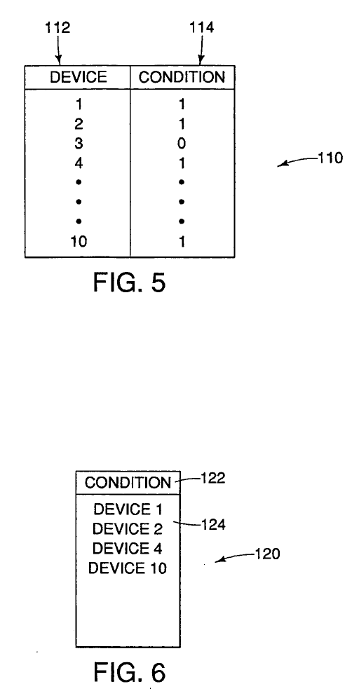

Referring to FIG. 5 a device and condition list 110 of all sender devices and their respective conditions as outputted from step 70 of the above process is illustrated. It will be appreciated that the list illustrated in FIG. 5 is representative only and that other variations on this list will also be useful as well. The device and condition list includes a devices list 112 and a corresponding condition list 114. The condition list 114 records the condition of each of the devices in the device list. In the present non-limiting example, the condition is selected to be a 1 or a 0 and is therefore a binary condition. It will be appreciated that other types of conditions may also be represented by known methods. It will also be appreciated that the device and condition list 110 is not limited to being in a tabular form, but may also be in a sequential list.

Referring to FIG. 6, an optimized single condition list 120 is illustrated as outputted from the message optimization process 80 above. The optimized single condition list 120 includes a condition portion 122 and a device identity portion 124. As illustrated, the device identity portion 124 includes a list of the devices having the condition set out in the condition portion 122.

It will be appreciated that for cases where there is more than one possible answer for the inquiry, a count for each possible answer may need to be compiled. In these cases, the more than one condition and associated list of devices may need to be produced by the message optimization process 80 so as to ensure that the condition of every device is listed or inferable from the reported conditions and lists of reported devices. In particular, it may be necessary to report one less condition than the total number of answers available such that the list of devices reporting the one condition that is not reported are known to be the devices not included on any of the other lists.

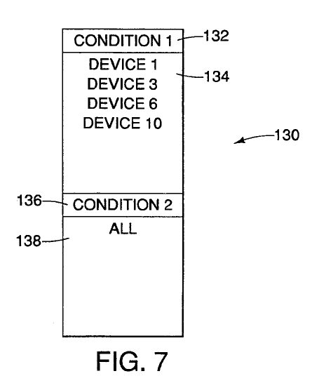

It will also be appreciated that the method set out above may be utilized to consolidate a message reporting more than one condition. In such an embodiment, the consolidating device may execute the message optimization process 80 as many times as there are conditions to consolidate. By why of non-limiting example, the consolidating device 30 may be requested to report the status of a portion of the network on a first condition and a second condition, for example the presence of flow and pressure. The consolidating device 30 will then execute the message optimizing process 80 a first time to determine an optimized list of the devices reporting flow and a second time to determine an optimized list of the devices reporting pressure. With Reference to FIG. 7, a two condition optimized message 130 is illustrated having a first condition portion 132 a first condition device list 134 a second condition portion 136 and a second condition device list 138. As illustrated by way of non-limiting example, the first condition device list 134 comprises a list of the devices having the first condition and the second condition device list 138 comprise “ALL” indicating that all of the devices have the second condition. It will be appreciated that messages may be optimized and consolidated for more than two conditions as well.

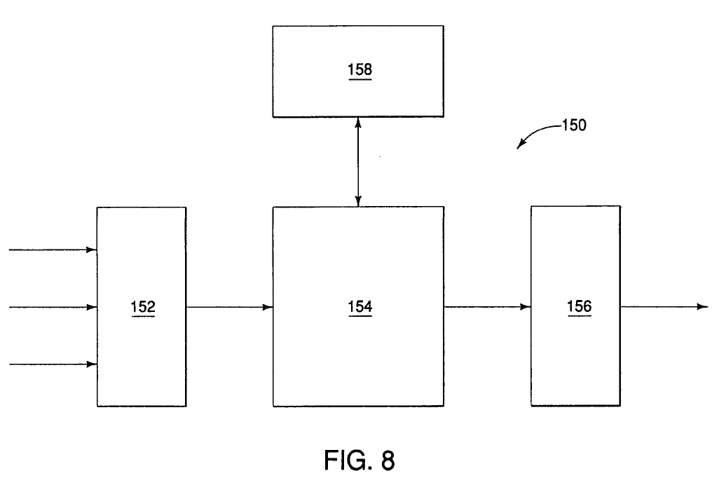

Turning now to FIG. 8, an apparatus, shown generally at 150, for optimizing messages in accordance with the above method is illustrated. The apparatus includes a receiver 152 for receiving reported messages from the other devices, a processor 154 and a transmitter 156 for outputting the optimized message from the apparatus 150. The apparatus may also optionally include a memory 158 for storing any of the lists referred to above. The receive 152 will receive messages from the other devices and transfer them to the processor 154. The processor 154 will store the received messages in the memory 158 until they are needed further. The processor 154 will perform the comparing and compiling functions described above utilizing the messages and data stored in the memory to compile and compose an optimized message. The processor 154 will then transfer the optimized message to the transmitter 156 for output to the master device 22 or another device through the network

While specific embodiments of the invention have been described and illustrated, such embodiments should be considered illustrative of the invention only and not as limiting the invention as construed in accordance with the accompanying claims.

What is claimed is:

1. A method of consolidating received messages from a plurality of devices, each of said received messages having a condition portion representing at least one condition being reported by at least one of said plurality of devices, the method comprising:
receiving at least one received message from said plurality of devices;
selecting at least one transmit condition from said at least one conditions being reported by said plurality of devices; and
transmitting a transmit message having a transmit condition portion and a transmit identifier portion,
wherein said transmit condition portion comprises said at least one transmit condition and wherein said transmit identifier portion represents said plurality of devices reporting said at least one transmit condition.

2. The method of claim 1 wherein each of said at least one conditions of said received messages is one of a set of mutually exclusive conditions.

3. The method of claim 2 wherein said set of mutually exclusive conditions comprises first and second conditions.

4. The method of claim 1 wherein each of said received messages further includes a received identifier portion representing a reporting group of said plurality of devices reporting each of said at least one condition.

5. The method of claim 4 wherein said received identifier portion comprises a list of said plurality of devices reporting each of said at least one conditions.

6. The method of claim 4 wherein said received identifier portion comprises a quantity of said plurality of devices reporting each of said at least one conditions.

7. The method of claim 1 wherein said plurality of devices report corresponding reported messages in an ordered sequence, wherein a unique identity of each of said plurality of devices is determined by a position of said device in said ordered sequence.

8. The method of claim 4 further comprising:
recording said at least one received messages;
compiling a condition count corresponding to each of said at least one condition being reported by said plurality of devices; and
comparing said condition counts,
wherein said selecting comprises selecting one of said condition counts so as to optimize the length of said transmit message.

9. The method of claim 8 wherein each of said condition counts corresponds to a quantity of said plurality of devices reporting said corresponding at least one condition.

10. The method of claim 9 wherein each of said condition counts includes a list of said plurality of devices reporting said corresponding at least one condition.

11. The method of claim 10 wherein said transmit condition is selected such that said transmit identifier portion is an optimized list selected from the group consisting of all of said plurality of devices, none of said plurality of devices and at least one of said condition counts.

12. The method of claim 11 wherein said at least one of said condition counts comprises half of all of said plurality of devices.

13. The method of claim 11 wherein said at least one of said condition counts comprises less than half of all of said plurality of devices.

14. The method of claim 8 wherein selecting comprises selecting one of said condition counts so as to optimize the length of said transmit message.

15. The method of claim 8 wherein selecting comprises selecting one of said condition counts so as to optimize the length of said transmit identifier portion of said transmit message.

16. The method of claim 1 wherein each of said received messages include a plurality of condition portions each represent a condition being reported by at least one of said plurality of devices.

17. The method of claim 16 wherein said transmit message comprises a plurality of said transmit conditions each having a transmit identity portion.

18. The method of claim 17 wherein said transmit message includes an optimized list of each transmit identifier portion for each of said transmit conditions.

19. The method of claim 1 wherein said plurality of devices comprise a predefined set of devices having known identifications.

20. The method of claim 1 wherein each condition portion represents a plurality of conditions being reported by at least one of said plurality of devices.

21. The method of claim 20 wherein said transmit condition comprises at least one condition selected to optimize a length of said transmit identifier portion.

22. The method of claim 1 wherein said message includes a plurality of condition portions each representing at least one condition being reported by at least one of said plurality of devices.

23. The method of claim 1 wherein said plurality of devices comprise a distributed network wherein said received messages are received at a first device of said distributed network.

24. An apparatus for consolidating received messages from a plurality of devices, each of said received messages having a condition portion representing at least one condition being reported by at least one of said plurality of devices, the apparatus comprising:
a receiver for receiving at least one received message from said plurality of devices;
a processor for selecting at least one transmit condition from said at least one conditions being reported by said plurality of devices; and
a transmitter transmitting a transmit message having a transmit condition portion and a transmit identifier portion,
wherein said transmit condition portion comprises said at least one transmit condition and wherein said transmit identifier portion represents said plurality of devices reporting said at least one transmit condition.

25. The apparatus of claim 24 further comprising a memory for recording said at least one received messages;

26. The apparatus of claim 25 wherein each of said received messages further includes a received identifier portion representing a reporting group of said plurality of devices reporting each of said at least one condition, wherein said processor is adapted to
compile a condition count corresponding to each of said at least one condition being reported by said plurality of devices in said memory; and
comparing said condition counts,
wherein said selecting comprises selecting one of said condition counts so as to optimize the length of said transmit message.
